(19) United States
(12) Patent Application Publication
(10) Pub. No.: US 2003/0077153 A1
(43) Pub. Date: Apr. 24, 2003

(54) Identification code reader integrated with substrate carrier robot

(75) Inventors: Martin R. Elliott, Round Rock, TX (US); Jeffrey C. Hudgens, San Francisco, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/036,060

(22) Filed: Oct. 19, 2001

(51) Int. Cl. B65G 1/04

(52) U.S. Cl. 414/281; 414/217.1; 118/719; 414/940

(57) ABSTRACT

An ID code reader, adapted to read an ID code from a wafer cassette or other substrate carrier, is integrated with a substrate carrier handling robot. In one aspect, the robot includes a support structure, and a chassis mounted for movement on the support structure. In this aspect an ID code reader is mounted on the chassis or otherwise mounted for movement along with an end effector adapted to engage the substrate carrier.

### FIELD OF THE INVENTION

The present invention is concerned with semiconductor manufacturing, and is more particularly concerned with apparatus for storing and moving carriers in which semiconductor substrates are stored.

### BACKGROUND OF THE INVENTION

Semiconductor devices are made on substrates, such as silicon wafers or glass plates, for use in computers, monitors, and the like. These devices are made by a sequence of fabrication steps, such as thin film deposition, oxidation or nitration, etching, polishing, and thermal and lithographic processing. Although multiple steps may be performed in a single processing station, substrates must be transported between processing stations for at least some of the fabrication steps. Substrates are stored in open cassettes or sealed pods (hereinafter collectively referred to as “substrate carriers”) for transfer between processing stations and other locations. Although substrate carriers may be carried manually between processing stations, the transfer of substrate carriers is typically automated. For example, a substrate carrier may be transported to a processing station in an automatic guided vehicle (AGV), and then loaded from the AGV onto a loading platform in the processing station by a robot. Another robot may extract a substrate from the substrate carrier and transport the substrate into a processing chamber at the processing station. When the fabrication steps are complete, the substrate is loaded back into the substrate carrier. Once all the substrates have been processed and returned to the substrate carrier, the substrate carrier is removed from the loading platform and transported to another location by the AGV.

Before or after extraction of substrates from the substrate carrier for processing, the substrate carrier may be stored on a storage shelf that is provided adjacent the processing station, or at a stocker unit that stores substrate carriers for a bay of processing stations.

For the purpose of controlling and tracking semiconductor manufacturing processes, it is known to provide machine-readable identification tags on substrate carriers such that a unique identification code is associated with each substrate carrier. It is also known to provide identification code (ID code) readers on each storage shelf and/or loading platform, so that the current location of each substrate carrier may be known to a system controller. However, a significant cost is required to install an ID code reader on each storage shelf or loading platform, and further costs are incurred to provide wiring required for a signal path between each ID code reader and the system controller. Furthermore, the ID code readers installed on storage shelves may take up space that is required for other purposes.

It would be desirable to eliminate ID code readers from substrate carrier storage shelves and loading platforms while maintaining substrate carrier tracking capabilities of semiconductor manufacturing systems. It could be contemplated to install an ID code reader only at one storage location or at a few storage locations and to transport a substrate carrier to a location at which an ID code reader is installed when it is desired to read the ID tag on the substrate carrier. However, such a practice would take a considerable amount of time and might place an excessive burden on the robot employed to transport substrate carriers.

### SUMMARY OF THE INVENTION

According to aspects of the invention there is provided an apparatus adapted to move a substrate carrier. The apparatus includes an end effector adapted to engage the substrate carrier and a support mechanism (e.g., a rotatable robot arm, or a linear guide, etc.) that supports the end effector for movement in at least one of a vertical direction and a horizontal direction. The apparatus further includes an ID code reader mounted on the support mechanism for movement therewith.

According to another aspect of the invention there is provided an apparatus adapted to move a substrate carrier. The apparatus includes a linear guide structure and a chassis mounted for movement on the linear guide structure. The apparatus further includes an end effector mounted on the chassis and adapted to engage (e.g., support) the substrate carrier, and one or more ID code readers mounted on the chassis or otherwise mounted to move along the linear guide structure (e.g., via a separate chassis).

According to still another aspect of the invention there is provided an apparatus adapted to store substrate carriers. The apparatus includes a plurality of shelves each adapted to support a substrate carrier, and a carrier handler adapted to place substrate carriers on, and remove substrate carriers from, the shelves. The carrier handler includes an end effector adapted to engage a substrate carrier, and a linear support mechanism that supports the end effector for movement in at least one of a vertical direction and a horizontal direction. The substrate handler further includes an ID code reader mounted on the support mechanism so as to move along the support mechanism either simultaneously (e.g., in a fixed relationship with) the end effector or independently from the end effector. The storage shelves may be disposed adjacent a docking station where wafers are extracted from a carrier and transported into a processing tool, thus forming a storage and loading apparatus. The docking station may include an automatic door opener adapted to remove a door of a sealed substrate carrier.

By integrating an ID code reader with a robot that transports substrate carriers, and mounting the ID code reader for movement with an end effector of the robot, reading of ID tags on substrate carriers can be conveniently accomplished, without providing ID code readers at substrate carrier storage locations. Thus the cost of and space occupied by a semiconductor manufacturing system may be reduced.

Further features and advantages of the present invention will become more fully apparent from the following detailed description of the preferred embodiments, the appended claims and the accompanying drawings.

### BRIEF DESCRIPTION OF THE DRAWINGS

FIG. 1 is an isometric view of a substrate carrier storage and loading station in which the present invention may be applied;

FIG. 2 is a front isometric view of a portion of a substrate carrier robot provided in accordance with the invention;

FIG. 3 is a side view of a portion of the substrate carrier robot of FIG. 2;

FIG. 4 is an isometric view showing a substrate carrier storage station having an ID code reader mounted on a separate chassis; and

FIG. 5 is an isometric view showing a substrate carrier storage and loading station having a plurality of ID code readers mounted along the substrate carrier's linear guide.

### DETAILED DESCRIPTION OF PREFERRED EMBODIMENTS

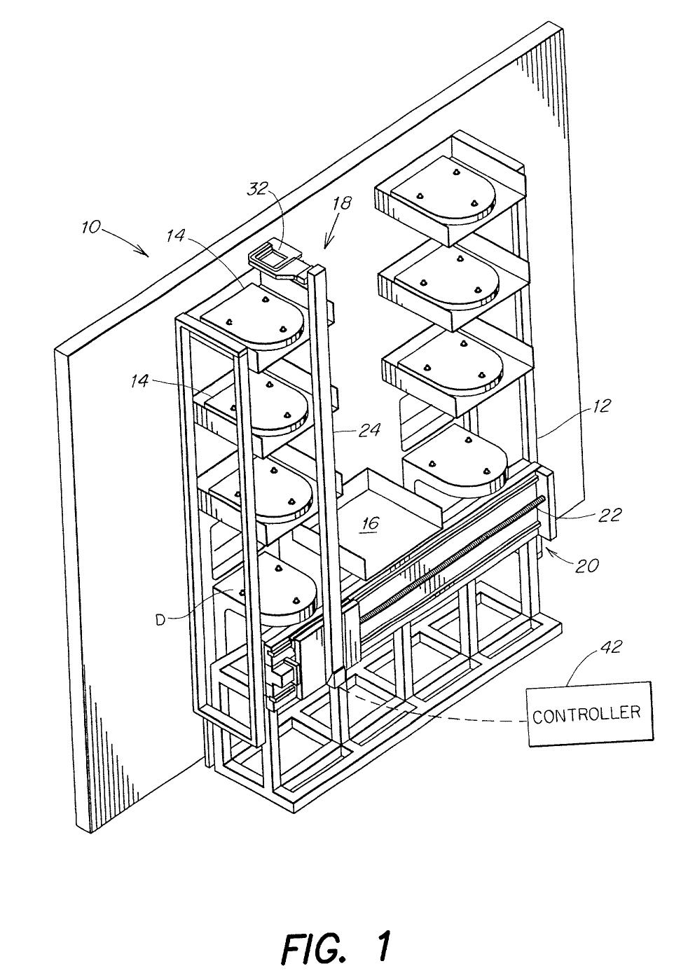

FIG. 1 is an isometric view of a substrate carrier loading and storage station 10. Although the loading and storage station 10 is shown in isolation in FIG. 1, in practice the loading and storage station may be installed adjacent to an interface to a substrate processing station. The interface to the substrate processing station may include one or more docking stations D on which a substrate carrier is positioned to permit a substrate-handling robot (not shown) associated with the substrate processing station to unload substrates from the substrate carrier and to load the substrates into the substrate processing station. The docking stations of the loading and storage station may further include automatic door openers for opening a door of a sealed substrate carrier. An exemplary automatic door opener is disclosed in U.S. Pat. No. 6,082,951 titled “Wafer Cassette Load Station”. The '951 patent is incorporated herein by reference in it's entirety. Likewise, an exemplary loading and storage station of the type illustrated in FIG. 1 is disclosed in co-pending U.S. patent application Ser. No. 09/201,737 (AMAT No. 2862), titled “Apparatus for Storing and Moving a Cassette”. The '737 patent application is incorporated herein by reference in its entirety.

As shown in FIG. 1, loading and storage station 10 includes a frame 12 on which storage shelves 14 are mounted. Also mounted on the frame 12 is a loading platform 16 for receiving substrate carriers to be stored. Preferably the plurality of storage shelves 14 share a common footprint (i.e., projected floor space) as the docking stations D.

The frame 12 also supports a carrier handler or robot 18 that transports substrate carriers among storage shelves 14, loading platform 16 and the above-mentioned docking station(s) D of the associated substrate processing station (not shown). The robot 18 includes a linear guide structure 20. The linear guide structure 20 of the robot 18 includes a horizontal guide 22 and a vertical guide 24 which is mounted for movement in a horizontal direction on the horizontal guide 22. Alternatively, although not shown, the horizontal guide may be mounted for movement in a vertical direction on the vertical guide.

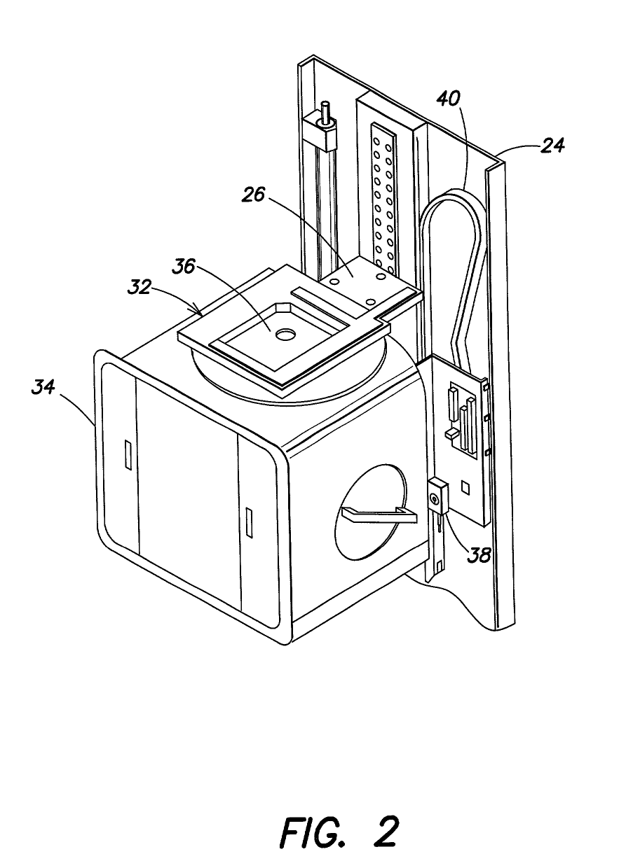

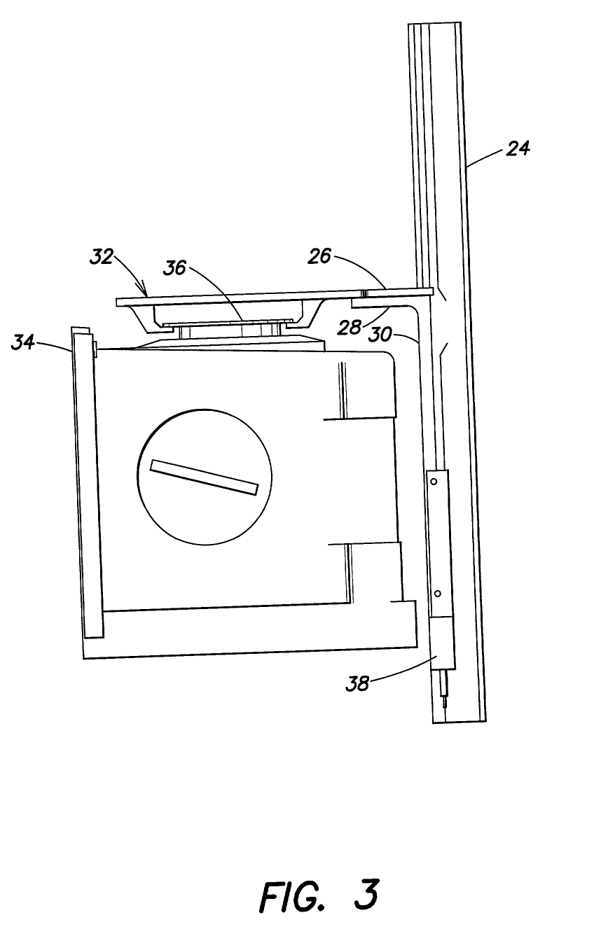

Referring to FIGS. 2 and 3, a robot chassis 26 is mounted for movement in a vertical direction on vertical guide 24. The chassis 26 may be generally in the shape of an inverted “L”, including a horizontally extending upper portion 28 and a main plate 30. Mounted to the upper portion 28 of the chassis 26 is an end effector 32. The end effector 32 is adapted to engage a substrate carrier 34 (e.g., by an upper flange 36 of the substrate carrier 34 conventionally referred to as an “overhead transport flange”). The substrate carrier 34 may be of a standard type, such as the well-known Front Opening Unified Pod (FOUP) or standard mechanical interface (SMIF) Pod. It will be appreciated that the robot 18 transports the substrate carrier 34 by engaging the substrate carrier 34 with the end effector 32 and then moving the chassis 26 on which the end effector 32 is mounted. The end effector may comprise a pair of ledges that extend parallel to the horizontal guide and are spaced by a distance less than the width of the substrate carrier's overhead transport flange. The end effector may engage the substrate carrier by moving horizontally to position the pair of ledges under the substrate carrier's overhead transport flange and then elevating such that the flange contacts the end effector ledges and the substrate carrier is supported thereby. An exemplary end effector is disclosed in U.S. patent application Ser. No. 09/894,322, filed Jun. 27, 2001, (AMAT No. 5769) the entire disclosure of which is incorporated herein by this reference.

In the aspect of FIGS. 2 and 3 an ID code reader 38 is mounted to the chassis 26 for movement with the end effector 32 (i.e., in this aspect both the end effector 32 and the ID code reader 38 are fixedly mounted to the chassis 26 so as to move as a unit therewith). In such an embodiment the configuration of the chassis 26, end effector 32 and ID code reader 38 may be such that the ID code reader 38 can read the ID of a substrate carrier when the end effector 32 is in position to pick up the substrate carrier. Because each shelf 14 preferably has positioning pins for locating a substrate carrier in a predetermined position as required by the SEMI (Semiconductor Equipment and Materials International) standard, the carrier handler 18 may move among the shelves 14 placing the end effector 32 adjacent the flange 36 of any substrate carriers on the shelves 14 (e.g., with the end effector ledges below but not in contact with the substrate carrier's overhead transport flange). Thus, the carrier ID's of substrate carriers stored on the shelves 14 can be read quickly and easily while the substrate carriers remain on the shelves 14. In fact, the carrier handler 18 does not even need to contact the substrate carrier to read the carrier's ID.

The ID code reader 38 may be of any type suitable for reading ID code tags installed on substrate carriers with which the loading and storage station 10 is operated. Accordingly, the ID code reader 38 may be a radio frequency identification (RFID) reader, a bar code reader, or an infrared (IR) reader. Preferably the ID code reader 38 is of a type that will only read the ID code tag of a substrate carrier 34 that is immediately adjacent the ID code reader 38. In certain embodiments of the invention, the reader 38 may be of the type employed in the V700 RFID system available from Omron, or the RS232-Transponder Reader available from Hermos.

ID code recognition signals outputted from the reader 38 are transmitted via a flexible cable 40 (FIG. 2) to a controller 42 (FIG. 1). Accordingly, the flexible cable 40 forms part of a signal path between the ID code reader 38 and the controller 42. The controller 42 controls operation of the loading and storage station 10 and may receive output from sensors (not separately shown) present on the storage shelves 14 and on other locations in the loading and storage station 10.

In operation the robot 18 is controlled to pick substrate carriers from and to place substrate carriers at the storage shelves 14, the loading platform 16 and docking stations D of the substrate processing system (not shown) associated with the loading and storage station 10. At the same time, the ID code reader is operated to read ID codes from substrate carriers that are transported by the robot 18 and/or substrate carriers that are located on storage shelves 14 or on loading platform 16 at times when the chassis 26 of the robot 18 is adjacent the storage shelves 14 or loading platform 16.

In one embodiment of the invention, the chassis 26 of the robot 18 is brought near to a storage shelf 14 or other position at which a substrate carrier to be moved is located. The ID code reader 38 then reads the ID tag of the substrate carrier and based on this information it is confirmed that the substrate carrier is indeed scheduled to be moved by the robot 18. The robot 18 then engages the substrate carrier by means of the end effector 32 to move the substrate carrier to its appointed new location.

If it should happen that the controller 42 loses track of the ID codes of the substrate carriers in the loading and storage station 10 (for example in the event of a power failure), the chassis 26 of the robot 18 may be moved in sequence so as to be near each of the storage shelves 14 to read in sequence the ID tags on the substrate carriers on all of the storage shelves 14. In this way ID information for all of the substrate carriers may be efficiently recovered after a system failure and the specific location of each substrate carrier is then known, as the controller may record ID information and ID code reader position (e.g., which storage shelf the ID code reader is adjacent to).

By incorporating an ID code reader with a substrate carrier handling robot, the present invention provides a cost effective and flexible mechanism for reading ID codes from substrate carriers. It is not necessary to install ID code readers at storage locations, and accordingly the cost of manufacturing the loading and storage station may be reduced, and space at the storage locations may be conserved.

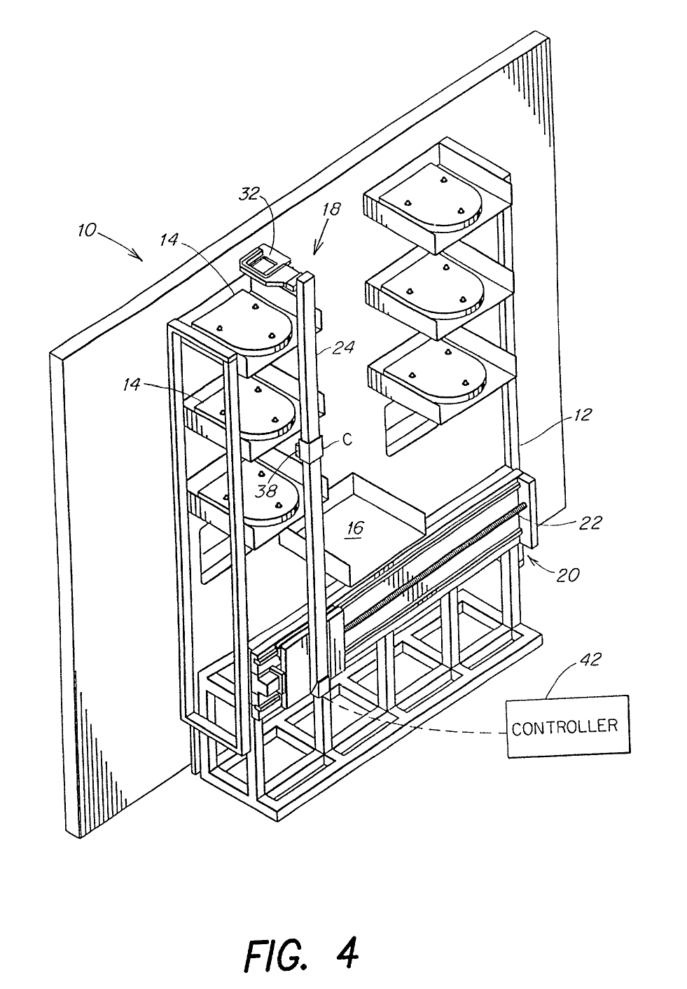

The foregoing description discloses only exemplary embodiments of the invention; modifications of the above disclosed apparatus which fall within the scope of the invention will be readily apparent to those of ordinary skill in the art. For example, although the present invention has been described in the context of a loading and storage station, it is also contemplated to apply the present invention in a substrate carrier handling robot associated with a central stocker unit or with any other apparatus in which substrate carriers are stored or positioned or transported. An exemplary central stocker may comprise the components of FIG. 1 except for the docking stations D, as shown in FIG. 4.

It will be understood that the ID reader may be mounted independently from the end effector, so that the end effector may move without causing the ID reader to move. For example, the ID reader may be mounted on any moving part of a carrier handler that may move past a substrate carrier location (e.g., a storage, load/unload location). In this aspect, the ID reader may be positioned adjacent a carrier ID independently of the end effector. FIG. 4 shows an ID reader mounted on a separately moveable chassis C from that of the end effector 32.

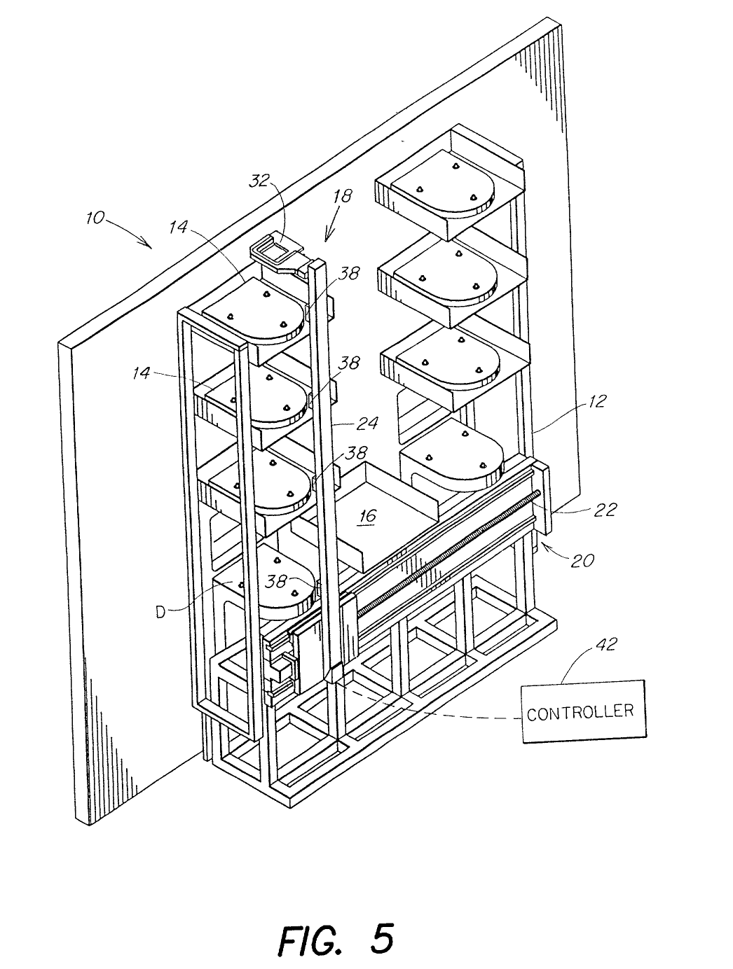

Further, when employed within a storage station 10 having a linear guide structure located adjacent a plurality of shelves, the carrier handler may have a plurality of ID readers vertically positioned along the carrier handler's vertical guide (as shown in FIG. 5), such that as the carrier handler moves horizontally, the ID's of carriers stored at differing elevations are simultaneously read. Likewise, in aspects where the horizontal guide is mounted for movement along the vertical guide, one or more ID readers may be mounted on the horizontal guide for simultaneously scanning one or more columns of storage shelves.

Accordingly, while the present invention has been disclosed in connection with a preferred embodiment thereof, it should be understood that other embodiments may fall within the spirit and scope of the invention, as defined by the following claims.

The invention claimed is:

1. An apparatus adapted to move a substrate carrier, comprising:
an end effector adapted to engage the substrate carrier;
a support mechanism that linear guides the end effector for movement in at least one of a vertical direction and a horizontal direction; and
an ID code reader mounted on the support mechanism for movement with the end effector.

2. The apparatus of claim 1, wherein the support mechanism supports the end effector and the ID code reader for movement in both a vertical direction and a horizontal direction.

3. The apparatus of claim 1, wherein the ID code reader is a bar code reader.

4. The apparatus of claim 1, wherein the ID code reader is a radio frequency ID reader.

5. The apparatus of claim 1, wherein the ID code reader is adapted to read an ID code carried by the substrate carrier.

6. The apparatus of claim 1, further comprising a controller adapted to receive ID code information read by the ID code reader.

7. The apparatus of claim 6, further comprising a flexible cable that constitutes at least part of a signal path between the ID code reader and the controller.

8. The apparatus of claim 1, wherein the end effector is adapted to engage a substrate carrier by an overhead transport flange.

9. A method of transporting a substrate carrier, comprising:
providing a carrier-handling robot that includes an end effector adapted to engage the substrate carrier; and
incorporating an ID code reader in the robot such that the robot moves the ID code reader with the end effector.

10. The method of claim 9, further comprising moving the ID code reader in a vertical direction and in a horizontal direction with the end effector.

11. The method of claim 9, further comprising:
positioning the end effector adjacent the substrate carrier; and
with the end effector positioned adjacent the substrate carrier, using the ID code reader to read an ID code tag on the substrate carrier.

12. The method of claim 11, further comprising:
positioning the end effector, in sequence, adjacent each one of a plurality of substrate carriers, and
using the ID code reader to read, in sequence, respective ID code tags on the plurality of substrate carriers.

13. The method of claim 12 further comprising:
storing ID code information with ID code reader position information so that the location of each of the plurality of substrate carriers is known.

14. The method of claim 9, wherein the substrate carrier is a Front Opening Unified Pod.

15. An apparatus adapted to move a substrate carrier, comprising:
a support structure;
a chassis mounted for movement on the support structure;
an end effector mounted on the chassis and adapted to engage the substrate carrier; and
an ID code reader mounted on the chassis.

16. The apparatus of claim 15, wherein the chassis is mounted for movement in a vertical direction and in a horizontal direction via a linear guide structure.

17. The apparatus of claim 16, wherein the support structure includes a horizontal guide, and a vertical guide mounted on the horizontal guide for movement along the horizontal guide; the chassis being mounted on the vertical guide for movement up and down the vertical guide.

18. The apparatus of claim 15, wherein the ID code reader is a radio frequency ID reader.

19. The apparatus of claim 15, wherein the ID code reader is a bar code reader.

20. An apparatus adapted to store substrate carriers comprising:
a plurality of shelves each adapted to support a substrate carrier; and
a carrier handler adapted to place substrate carriers on, and remove substrate carriers from, the shelves;
wherein the carrier handler includes:
an end effector adapted to engage a substrate carrier;
a support mechanism that supports the end effector for movement in at least one of a vertical direction and a horizontal direction; and
an ID code reader mounted on the support mechanism for movement with the end effector.

21. The apparatus of claim 20, wherein the support mechanism comprises a linear guide structure that supports the end effector and the ID code reader for movement in both a vertical direction and a horizontal direction.

22. The apparatus of claim 20, wherein the ID code reader is a bar code reader.

23. The apparatus of claim 20, wherein the ID code reader is a radio frequency ID reader.

24. The apparatus of claim 20, wherein the ID code reader is adapted to read an ID code carried by the substrate carrier.

25. The apparatus of claim 20, further comprising a controller adapted to receive ID code information read by the ID code reader.

26. The apparatus of claim 25, further comprising a flexible cable that constitutes at least part of a signal path between the ID code reader and the controller.

27. The apparatus of claim 20, wherein the end effector is adapted to engage a substrate carrier by an overhead transport flange.

28. The apparatus of claim 20, further comprising a frame on which the shelves and the carrier handler are mounted.

29. The apparatus of claim 20 further comprising a docking station.

30. The apparatus of claim 29 wherein the plurality of storage shelves are positioned above the docking station.

31. The apparatus of claim 29 wherein the plurality of storage shelves and the docking station have a common footprint.

32. A substrate carrier handler, comprising:
a support mechanism;
an end effector adapted to engage a substrate carrier and moveably mounted on the support mechanism;
a moving member moveably mounted on the support mechanism; and
an ID code reader mounted on the moving member.
